(19) United States
(12) Patent Application Publication
(10) Pub. No.: US 2006/0225667 A1
(43) Pub. Date: Oct. 12, 2006

(54) Flexible configuration dog bone

(76) Inventors: Simon Handelsman, Newburyport, MA (US); Glen S. Axelrod, Colts Neck, NJ (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/100,333

(22) Filed: Apr. 6, 2005

(51) Int. Cl. A01K 29/00

(52) U.S. Cl. 119/710

(57) ABSTRACT

A flexible configuration pet toy is provided which may comprise a hard plastic or rubber construction yet have a flexible shaft. The toy may include two condyles connected by a series of interconnected links in a dog bone configuration which allows for a hard surface yet flexible shaft. A plurality of links may be arranged together to provide a shaft capable of motion in more than one axis. The links may be pinned together and to the condyles to provide a toy having an adjustable configuration.

### FIELD OF INVENTION

The present invention relates to pet toys, particularly ones shaped like dog bones. More particularly, the present invention relates to dog bone shaped pet toys that are flexible and still provide hard surfaces upon which an animal may chew.

### BACKGROUND

Pet toys are widely known in the prior art. Particularly, pet toys are provided for animals to chew on. Dogs in particular are known for their penchant to chew upon objects. Most dogs enjoy chewing on things, although preferences vary as to the hardness of the substances favored. Some dogs like to chew on very hard materials such as cow bones, wood and nylon, while others prefer softer chews such as polyurethane or rubber. Still others favor freeze dried snacks. Some dogs due to their age, may not be able to chew on very hard substances. Young dogs may have insufficiently developed teeth, while old dogs may have diseased gums or may have lost some of their teeth. Preferably, toys are a distraction to which the dog, or any other pet, will direct its attention and chew upon instead of other coveted items such as hats, shoes, table legs, etc. Many attempts have been made at creating toys that attract pets, such as providing toys in the shape of dog bones and adding attractants to the toys. Pet toys such as dog chews may be produced in the form of strips or toys or even bone shapes, generally having a larger end and smaller shaft to allow the dog to easily pick them up. Dogs generally will hold a dog chew between their paws in order to chew it and thus the chew needs to be provided with a means for easy access to maintain interest.

Another purpose of animal toys has been to provide a hard surface upon which the animal's teeth may be scraped. Animal pets, such as dogs and cats, are subject to dental health problems. These problems can be traced to the formation of bacterial plaque that forms on the exterior of teeth. Tartar is the result of the thickening and hardening (mineralization) of the plaque. Dental prophylaxis is promoted in pets, and especially dogs, by the scraping of relatively hard surfaces against the pet's teeth.

Furthermore, these toys provide exercise for the animals by encouraging play. To accomplish these goals, pet toys have been provided in a variety of shapes and materials. Examples of various shapes of pet toys include, but are not limited to, the following.

U.S. Pat. No. 6,360,693 discloses an apparatus for use as a toy by an animal that resembles a branch in appearance.

U.S. Pat. No. 6,148,771 reports a chew article of elastomeric material having an outer surface with a number of grooves. Furthermore, there is an interior cavity in which edible material may be stored and released in a controlled manner while using the chew article.

U.S. Pat. No. 5,339,771 discusses a chew toy molded from synthetic plastic. Animal meal is dispersed throughout the synthetic plastic.

U.S. Pat. No. 4,771,733 describes a chewable object or toy formed of a polyurethane resin with an aqueous-based flavor or odor incorporated therein.

Flexible chew toys are reportedly easier for an animal to manipulate. Particularly for dogs, a toy which is “floppy”, that is, flexible in the center section and bulkier on the ends, may provide the sensation perhaps of having captured another animal. Traditionally, flexible chew toys have been provided in the form of ropes or other soft materials. For example, U.S. Pat. No. 5,711,254 discloses a dog chew that has a length of composite rope having an inner core and an outer shell. The inner core contains natural plant or synthetic fibers and the outer shell includes cotton fibers.

U.S. Pat. No. 5,392,734 discusses a chew toy made out of a number of flexible rope arms which depend from a rope knot node. Each arm has a braided middle portion and an unbraided open-stranded free end.

U.S. Pat. No. 5,174,243 reports a chew toy having a soft rope shaft portion and plastic end members secured to the ends of the shaft portion.

U.S. Pat. No. 5,078,637 discloses a flexible flying disc that is made out of soft flexible material.

U.S. Pat. No. 4,133,296 discusses a toy for an animal that is formed of an elongated flexible tubular member. The tubular member also has pockets to hold weight parts.

However, these flexible chew toys do not provide the relatively hard surfaces some dogs and other animals prefer to chew upon that may further provide dental prophylaxis.

While the above certainly contribute to the art of providing durable chewable pet toys, there is still a need for improvement. It is an object of the present invention to improve upon the art of pet chews by providing a relatively flexible animal chew toy that includes a relatively hard chewing surface, and which may promote dental prophylaxis and which may encourage play.

### SUMMARY

The present invention is directed to a flexible toy for an animal comprising a shaft portion and at least one end portion connected to the shaft portion, the end portion including a tongue portion extending therefrom. The shaft portion includes a first link, wherein the first link includes a base. The base includes a pair of first tongue portions extending therefrom and a single second tongue portion extending therefrom.

In method form, the present invention is directed at a method of forming a pet toy having a hard surface and a flexible shaft comprising the steps of providing at least one end portion, said end portion including a tongue portion including a hole. A shaft is provided including a first link, wherein the first link includes a base. The base has a pair of first tongue portions extending therefrom and a single second tongue portion extending therefrom, each of the tongue portions including a hole. This is followed by engaging the tongue portion of the end portion between the pair of first tongue portions of the first link. One then provides a pin and inserts the pin through the holes in the pair of first tongue portions of the first link and through the tongue portion of the end portion to connect the end portion to the first link.

### BRIEF DESCRIPTION OF DRAWINGS

FIG. 1 illustrates a pet toy known in the prior art.

FIG. 2 is a plan view of one embodiment of the present invention.

FIG. 3 is a plan view of one of the ends of the pet toy of the present invention.

FIG. 4 is a plan view of one of the links of the present invention.

FIG. 4A is a plan view of an alternate design for one of the links of the present invention.

FIG. 5 is a plan view of one of the pins which connect together the links and ends of the present invention.

FIG. 6 is a sectional view of two links of the present invention aligned together so that the pin of FIG. 5 may be installed to connect the links together and further illustrating a retention mechanism for the pin.

FIG. 7 is a plan view of an alternate detent design for the link of FIG. 4A.

### DETAILED DESCRIPTION OF THE INVENTION

The present invention relates to a flexible pet toy, capable of flexing due to one or more links arranged along the length of the toy. Preferably, the chew toy is in the form of a dog bone or other shape that attracts an animal.

In one embodiment of the present invention, the flexible chew toy comprises a series of joints. Preferably, the joints may be created by connecting individual links. More preferably, the links are arranged in a manner that provides nearly universal motion or motion about more than one axis.

In another embodiment, the links may be pinned together in a manner allowing free motion of the links. More preferably, the pins may be designed so as not to be easily removed. Preferably, the pins may be designed as push-in snap fasteners. More preferably, the fasteners may be constructed of the same or a similar material as the rest of the toy.

In one embodiment, the toy may be molded from a thermoplastic or thermoset plastic, or a rubber material. Preferably, the thermoplastic material may be a relatively hard plastic such as, but not limited to, nylon or polyurethane or even starch blends, including blends of starch and a thermoplastic aliphatic-aromatic co-polyester resin and mixtures thereof. Alternatively, the hard rubber material may be a co-polymer rubber, (such as poly(styrene-butadiene-styrene) rubber), polyisoprene, polybutadine, polyisobutylene, silicone or mixtures thereof.

In other embodiments of the present invention, features may be added to the toy. The features may include, but are not limited to, an attractant in the form of a flavoring or scent dispersed within the polymer matrix, pigments of various colors to provide visual stimulation including phosphorescent pigments which may provide a glow-in-the-dark capability, texturing of the toys' surface to provide oral stimulation and the inclusion of devices which emit sounds or light energy when the toy is flexed or compressed.

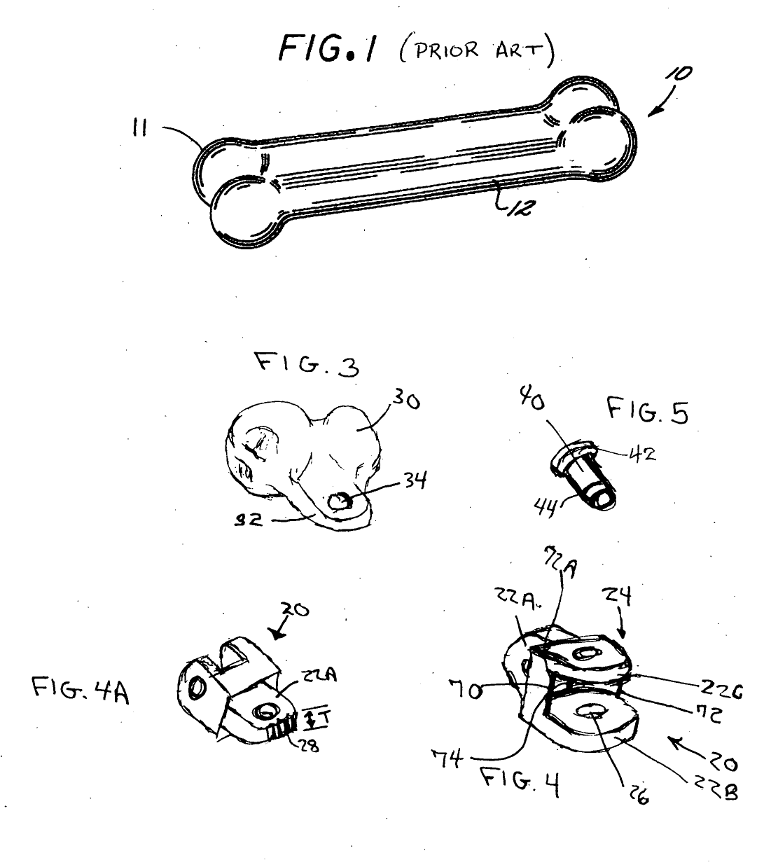

FIG. 1 illustrates a typical example known in the prior art of a toy that dogs may chew on, shaped like a bone. These are relatively flat shapes, illustrated at 10 with a smaller shaft portion indicated at 12 in FIG. 1 and one or more larger or more bulbous ends 11 which assist the dog in picking up the toy. However, the dog must generally prop up one end of the toy on a paw or on another raised surface in order to get the toy in a position along the dog's jaw for serious chewing and enjoyment. This toy is generally of a relatively hard composition and very rigid, which is acceptable for chewing upon, but which provides no enjoyable feedback to the dog for shaking or playing. Further, the rigid shape is not adjustable or configurable to make it easy for the dog to pick up.

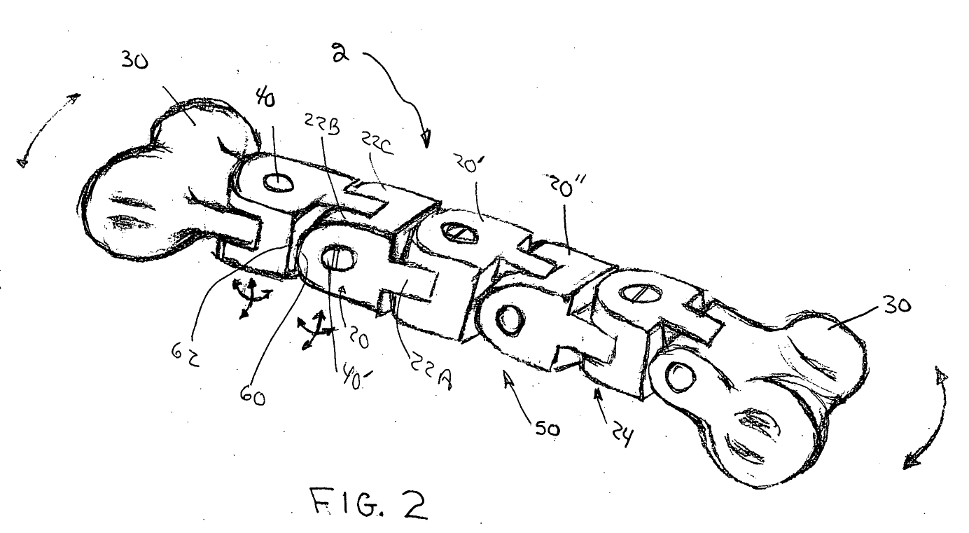

FIG. 2 is a plan view of one embodiment of the pet toy of the present invention. The toy comprises a one or more interconnected links 20 forming a series of flexible joints which comprise a flexible shaft 50 which may be terminated at each end by a more bulbous head or condyle 30. The interconnected links 20 may preferably include a pair of tongue portions 22B, 22C extending outward in an essentially parallel fashion from a base and a single tongue portion 22A extending out from the base, the single tongue portion sized to fit between a pair of tongue portions of an adjacent link 20′. The tongue portions each have a curved end 60, in an essentially U-shape or C-shape, which allows the shaft 50 of the toy 2 to be flexible and adjustable or configurable to a wide range of shapes. By being curved, it does not interfere with an adjacent wall 62 of an adjacent link and allows rotation of the link 40 around a pin 40′. Alternatively, the wall of one link 62 may be curved in an essentially U or C-shape and the protruding tongue end 60 may be of a more flat shape. The toy 2 may include, for instance, one link 20 connecting the condyle 30 (e.g. a knuckle shaped end of a bone) or a large number of links 20 to provide a more “floppy” and flexible toy, say for a larger dog, connecting two condyles.

The links 20 may be interconnected by inserting pins 40 into apertures formed in each of the tongue portions. The pins may be snapped in place and/or rotated one-quarter turn to lock the pin in place and resist removal by the dog.

All of the elements of the toy 2 may be preferably molded of a hard plastic or rubber to provide the dog with enjoyment and improve the health of the dogs' teeth.

The larger bulbous heads 30 in combination with a flexible shaft 50 may serve to promote the “floppiness” or ability for the toy to flex when shaken.

FIG. 3 illustrates one of the end portions or condyles 30 of the present invention. The condyle 30 is preferably shaped like a knuckle or the head of a bone and includes a tongue portion 32 protruding from one side which engages between a pair of tongue portions of a U-shaped end 24 of the link 20. (See FIG. 4.) Alternatively, the condyle or end portion may include a pair of tongue portions extending outward which would connect with a single tongue portion of an adjacent link.

Both tongue portion 32 and U-shaped end 24 include a central hole 34, 26 which when aligned may receive a pin 40 to form a flexible joint. Connecting a series of tongue portions and a plurality of U-shaped ends together may provide a toy of any length which has a flexible shaft.

FIG. 4 is a view of an individual link 20. The link 20 preferably includes a body portion 70 from which three tongue portions may extend, each having a central hole 26 for fastening to an adjoining link 20′ or condyle 30. The protruding tongue portions of the link 20 preferably protrude from one side of the body portion 70 as a single tongue 22A and from another side of the body portion 70 as a pair of tongues 22B, 22C. Each of the tongue portions preferably have a U-shaped end such that when pinned adjacent another link or condyle some rotation of one link around the pin may occur. The double tongue portions 22B and 22C are spaced apart by at least the thickness (T) of the single tongue portion 22A such that interconnecting the tongue of adjacent links form a flexible or “universal” joint. While in one embodiment the flexing action of the various links 20 may be desired to be smooth, in an alternate embodiment it may be preferred to provide some resistance to flexing of the shaft 50 of the toy 2 such that the toy 2 may be posed in a certain position or maintained in a curved configuration. The inner portion of the link 20 preferably is formed into a concave and curved shape that complements the U or C-shape of the end of the tongue portions to again allow some amount of rotation of one link relative to an adjacent link. In FIG. 4 this inner portion is bounded by walls 72,72A.

In addition, as illustrated in FIG. 4, and in a preferred embodiment, the tongue portions 22A, 22B and 22C are configured such that tongue portion 22A extends longitudinally in a parallel configuration to tongue portions 22B and 22C. That is, they extend all in the same general plane. Alternatively, it can be appreciated that tongue portions 22A may extend in a perpendicular configuration (not shown) to tongue portions 22B and 22C, that is extending outward from the base 70 at a generally right angle. In addition, all configurations between a generally parallel and generally perpendicular configuration are herein contemplated.

FIG. 4A illustrates a similar link 20 wherein a series of ridges or detents 28 have been provided on the end of the single tongue 22A. These can be designed to be of a dimension to interfere with an outer wall 72, 72A of the body portion 70 of an adjacent link 20′ such that rotation of one link 20 around the pin 40 relative to an adjacent link provides the interference of ridges 28 with outer wall 72 or 72A. Alternatively, the ridges or detents 28 may engage or interfere with a protrusion 74 on the inner concave portion of the base 70 between the double tongue portions 22B or 22C.

In an alternate link design shown in FIG. 7, an alternate detent mechanism is shown. The tongue portion 22A may include a series of radial grooves or ridges 29 which engage with a similar series of radial ridges or grooves in the inside surface of tongue 22B and/or 22C (FIG. 4) of an adjacent link to provide some resistance to free movement of the links 20 relative to one another.

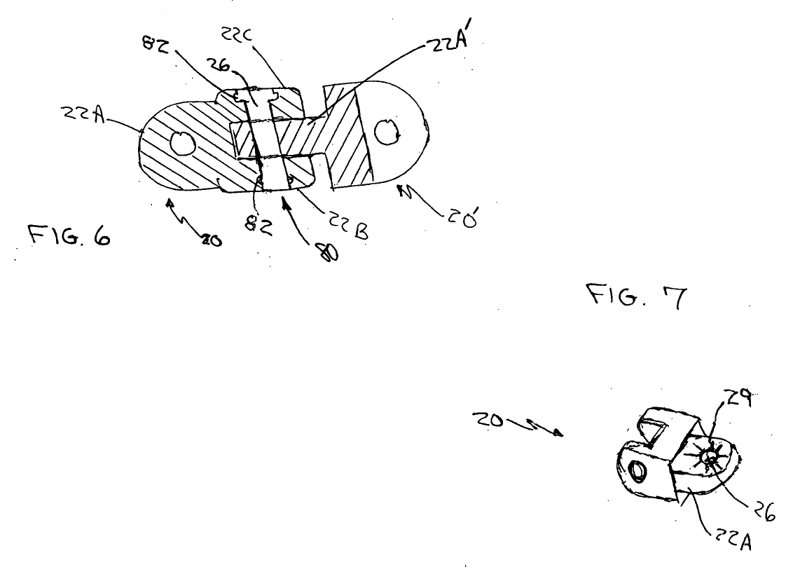

FIG. 5 illustrates the pin 40 which is used to connect the various links 20 and condyles 30 together. The pin preferably has a larger head 42 at one end which fits flush into a hole 26 in a tongue portion 22C of a link 20. The pin 40 further extends through the hole in tongue portion 32 for a condyle 30 (or 22A for another link 20′) and into a hole in tongue portion 22B to connect the links of the toy 2 together (see FIG. 2).

FIG. 6 illustrates the flexible joint in cross-section. Here a first link 20 is connected to a second link 20′ by inserting a tongue section 22A′ into the U-shaped section 24 of link 20 which comprises tongue 22B and 22C. This aligns the holes 26 in each tongue to provide an opening 80 for a pin 40 to snap into. Small detents or ridges (44 in FIG. 5) in the outer circumference of the pin 40 near one or both ends may interfere with or snap into mating grooves 82 in the wall of hole 26 in tongue 22B or 22C.

In a preferred embodiment, the pet toy 2 of the present invention comprises end portions or condyles 30 which are identical and formed from a single tool or tool shape and the links 20 are all replicates so that a minimum number of injection molding tools may be required to provide efficiency of manufacturing and cost. Alternatively, each element (link, condyle) of the toy may be of a different color, shape, texture or include a different feature to provide a broader experience for the animal. For instance, the condyles 30 may be molded of a material which is somewhat softer than the shaft portion 50.

Since the toy 2 is preferably molded at least in part of plastic, the toy should easily float and be useful to have the dog fetch even in water environs where it will be easy to retrieve.

The foregoing description is provided to illustrate and explain the present invention. However, the description hereinabove should not be considered to limit the scope of the invention set forth in the claims appended here to. It may be seen that the present invention and the embodiments disclosed herein and those covered by the appended claims are well adapted to carry out the objectives and obtain the goals set forth. Certain changes can be made in the subject matter without departing from the spirit and scope of the invention. It is realized that changes are possible within the scope of this invention and it is further intended that each element or step recited in any of the following claims is to be understood as referring to all equivalent elements or steps. The following claims are therefore intended to cover the invention as broadly as legally possible in whatever form it may be utilized.

What is claimed is:

1. A flexible toy for an animal comprising:
a shaft portion and at least one end portion connected to said shaft portion; said end portion including a tongue portion extending therefrom;
said shaft portion including a first link,
wherein said first link includes a base; said base having a pair of first tongue portions extending therefrom and a single second tongue portion extending therefrom.

2. The flexible toy of claim 1, wherein said single second tongue portion of said first link is arranged in relation to said pair of first tongue portions of said first link in a manner selected from the group consisting of substantially parallel, substantially perpendicular and arrangements in between.

3. The flexible toy of claim 1, wherein said tongue portion of said at least one end portion engages between said pair of first tongue portions of said first link.

4. The flexible toy of claim 1, further supplying a second link which includes a base, said base having a pair of first tongue portions extending therefrom and a single second tongue portion extending therefrom, wherein said single second tongue portion of said first link engages between said pair of first tongue portions of said second link.

5. The flexible toy of claim 1, wherein an aperture is disposed in said pair of first tongue portions of said first link and in said single second tongue portion of said first link and in said tongue portion of said at least one end portion, including a pin positioned through said apertures.

6. The flexible toy of claim 5, wherein said pin is snap-fit into said apertures.

7. The flexible toy of claim 5, wherein said pin is composed of substantially the same material as said at least one link.

8. The flexible toy of claim 4, wherein said first link and said at least one end portion and said second link are arranged so as to flex along more than a single axis.

9. The flexible toy of claim 1, wherein said toy includes a second end portion, said second end portion including a pair of tongue portions extending therefrom, said pair of end portions engaging a single tongue portion of said first link.

10. The flexible toy of claim 9, wherein at least one of said end portions comprises a condyle in the shape of a dog bone.

11. The flexible toy of claim 1, wherein said toy comprises a rubber material, a thermoplastic material, a thermoset material and mixtures thereof.

12. The flexible toy of claim 11, wherein said thermoplastic material comprises nylon, polyurethane, starch and mixtures thereof.

13. The flexible toy of claim 11, wherein said rubber material comprises copolymer rubber, polyisoprene, polybutadine, polyisobutylene, silicone and mixtures thereof.

14. The flexible toy of claim 11, further comprising an attractant dispersed within said material.

15. The flexible toy of claim 1, wherein said at least one end portion further comprises a surface and projections extending from said surface.

16. The flexible toy of claim 1, wherein the at least one end portion and said link are not comprised of the same material.

17. A method of forming a pet toy having a hard surface and a flexible shaft comprising the steps of:
providing at least one end portion, said end portion including a tongue portion including a hole;
providing a shaft portion including a first link, wherein said first link includes a base; said base having a pair of first tongue portions extending therefrom and a single second tongue portion extending therefrom, each of said tongue portions including a hole;
engaging said tongue portion of said at least one end portion between said pair of first tongue portions of said first link;
providing at least one pin; and
inserting said pin through said holes in said pair of first tongue portions of said first link and through said tongue portion of said end portion to connect said end portion to said first link.

18. The method of claim 17 further including the steps of;
supplying a second link comprising a pair of first tongue portions extending therefrom and a single second tongue portion extending therefrom, each tongue portions including a hole;
engaging said single tongue portion of said first link between said pair of first tongue portions of said second link; and
supplying a pin and inserting a pin through said holes in said pair of first tongue portions of said second link and through said holes in said single second tongue portion of said first link to connect said first and second links.

19. A toy for a pet, comprising:
(a) a flexible shaft portion comprising a first link,
(b) at least one end portion attached to said shaft,
(c) at least one pin;
wherein said first link includes a base; said base having a pair of first tongue portions extending therefrom and a single second tongue portion extending therefrom; wherein said at least one end portion includes a tongue portion extending therefrom; wherein said tongue portion of said at least one end portion engages between said pair of first tongue portions of said first link; and
wherein an aperture is disposed in said pair of first tongue portions and in said tongue portion of said at least one end portion and said pin connects said first link and said at least one end portion through said aperture.
